(19) United States
(12) Patent Application Publication
(10) Pub. No.: US 2006/0028988 A1
(43) Pub. Date: Feb. 9, 2006

(54) Decreased random opening procedure for overload control

(76) Inventors: Gopal N. Kumar, Morristown, NJ (US); Aparajita Misra, Basking Ridge, NJ (US); Ganapathy Subramanian Sundaram, Hillsborough, NJ (US)

Correspondence Address: CARLSON, GASKEY & OLDS, P.C., 400 WEST MAPLE ROAD, SUITE 350, BIRMINGHAM, MI, 48009, US

(21) Appl. No.: 10/914,545

(22) Filed: Aug. 9, 2004

(51) Int. Cl. H04L 12/26; H04J 3/14

(52) U.S. Cl. 370/232

(57) ABSTRACT

A communication network includes an overload control algorithm that reduces the number of messages that need to be opened, which reduces the computational cost of the overload control algorithm while still accounting for relative priorities among various message classes. In one example, statistical probabilities based upon arrival rate information provide the ability to determine a sufficient number of messages to open to ensure that the number of acceptable messages are processed. Messages exceeding the sufficient number are throttled without opening them. By not opening such messages, the computational cost otherwise associated with opening them is avoided. The statistical information based upon the arrival rate for a plurality of message classes provides a sufficient likelihood that the appropriate number of acceptable messages will be opened so that system performance is not compromised.

### FILED OF THE INVENTION

This invention generally relates to telecommunication and more particularly to wireless communication systems.

### DESCRIPTION OF THE RELATED ART

Wireless communication systems have grown increasingly in popularity and in capabilities. Current systems provide voice communication, data communication and other multi-media applications. As technology progresses, the capabilities in these areas continue to improve.

Managing the flow of information in such systems is of critical importance. For example, a variety of messages must be processed by a system controller for optimal communications to be maintained. Typical controllers or processors have a maximum capacity. Under most circumstances, the capacity is not reached and the processor occupancy (PO) is at a level that allows for effective maintenance of the desired communications among subscribers within a network, for example. There are times, however, when the PO exceeds the controller capacity and measures must be taken to handle such overload situations.

Data flow in a wireless network is typically bursty; there may be periods with low volumes and others with high volumes. It follows that even with a manageable average traffic volume, a processor may experience instantaneous processing loads that exceed the average value and may exceed the processor capacity. Such situations must be dealt with effectively to avoid end-to-end delays and other quality-of-service deteriorations. Handling an overload situation and minimizing the amount of time it would take to recuperate from such a situation is important. Ideally, processors are protected from overload situations using overload control algorithms.

Known overload control algorithms react to an overload situation by reducing a processor's exposure to message processing loads. Typical messages included are signaling messages, data-payload or operations messages and maintenance messages. A typical algorithm will drop or delay some of these messages using some form of negotiation with the source or buffer for some of the messages to effectively reduce the number of messages to be handled by the processor in a given interval. Some algorithms combine dropping and delaying techniques. The effectiveness of an algorithm depends upon how it reacts to different messages. Some algorithms do not discriminate among messages while others recognize relative message priorities and use such information when deciding what message(s) to drop or delay.

System performance metrics determine how important a given message is. Some overload control algorithms include attributing importance to different message types. Relative priorities of messages sometimes dictate how messages are to be dropped during overload situations. For example, if there are multiple classes of subscribers based upon their subscription rates, those paying more for services will have higher priority than those paying less. Some message types are higher priority based on content.

Simply dropping the lowest priority messages may not solve an overload problem where a large number of high priority messages are arriving within a certain time interval. An overload algorithm typically requires an ability to determine how many messages of each priority should be dropped to address an overload situation.

One major shortcoming of typical overload control algorithms is that they require opening each message to determine its priority and whether a particular message will be processed or dropped. Opening each message is computationally expensive. An overload control algorithm that imposes too high of a computational cost to determine priority information typically is not used because of the additional computational cost. This is a significant reason why priority-sensitive overload control is not implemented as often as would be beneficial.

There is a need for an improved overload control algorithm that is able to discriminate between different priority messages without being computationally expensive. This invention addresses that need by providing an overload control approach that reduces the number of messages that need to be opened and, therefore, streamlines the discrimination process.

### SUMMARY OF THE INVENTION

In general terms, this invention is an overload control approach that utilizes statistical information to decrease the number of messages that need to be opened during overload control.

One example method of handling message overload includes throttling a number of unopened messages based upon relative arrival rates of different message classes. In one example, the throttling includes at least one of discarding a message or delaying processing of a message.

In one example, determining an allowable number of messages to be processed and a sufficient number of messages to be opened to include the allowable number of messages provides a threshold above which any messages received can be throttled without opening them.

In one example, the arrival rate of messages of various classes and their respective relative priorities are used to determine an acceptance fraction for each class. The sufficient number of messages to be opened is based upon the acceptance fraction of each class and relative frequency of occurrence of each class so that the sufficient number includes statistically enough messages within the maximum allowable limit for each class that can be accepted. This number of messages is accepted as an ensemble without opening. This rationale can be used to accept a certain number of messages without opening them or throttling a certain number without opening them.

By reducing the number of messages that are opened, the computational requirements of an overload control algorithm that accounts for relative priorities among message classes can be greatly reduced. Disclosed embodiments take advantage of arrival rate information and provide the ability to throttle messages without opening them based upon the arrival rate information and a current acceptance fraction.

The various features and advantages of this invention will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of a wireless communication network.

FIG. 2 is a flow chart diagram that schematically illustrates features of an example embodiment.

### DETAILED DESCRIPTION

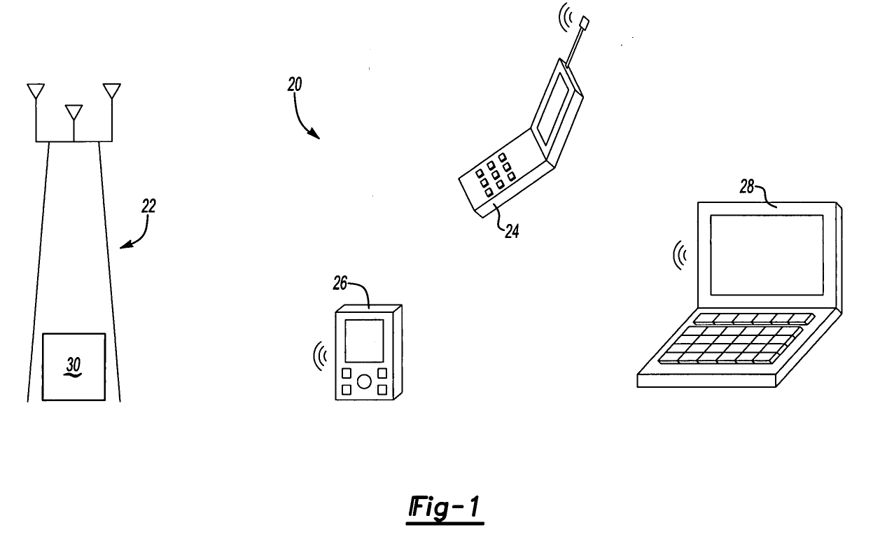

FIG. 1 schematically illustrates a wireless communication system 20 that includes a base station 22 and a plurality of mobile units 24, 26 and 28. The mobile units are any of a variety of commercially available communication devices that are capable of data or voice transmissions through a wireless communication interface such as a cell phone 24, a personal digital assistant 26 or a notebook computer 28. Of course, this invention is not limited to any particular mobile unit. The illustrated examples are provided to show different types of user devices that may be used.

The base station 22 includes a system controller 30 that includes known radio equipment and signal processing equipment that is useful for generating and processing data and communication signals in a wireless network. The controller 30, for example, includes the necessary electronics and software for deciphering and managing messages received at the base station. The message processor portion of the controller 30 may take a variety of known forms. It should also be noted that a processor need not be located at a base station or be directly linked with a base station for it to benefit from the overload control provided by this invention.

The message processor of the controller 30 receives a variety of messages during normal system communications. Various message types are known. During situations where the processor occupancy (PO) reaches a threshold, which may correspond to the processor capacity or may be set at a lower limit, overload control becomes necessary. According to one example, the overload control sets an acceptance fraction for each of a plurality of message types or classes. There are known techniques for identifying message types and assigning acceptance fractions to different message types. The acceptance fractions dictate whether a particular message will be throttled as part of an overload control procedure. Throttling may include delaying processing of a message, dropping a message or a combination of them.

An acceptable fraction is one example overload control parameter that is useful for determining how many messages can be processed within a given PO. Other control parameters such as a rejection fraction, a residue value or a critical value may be used in an embodiment of this invention. The term “acceptance fraction” as used in this document should not be construed in a most limiting sense. Instead, it should be considered exemplary of an overload control parameter. In fact, the acceptance fraction, rejection fraction and residue can be mapped to each other quite easily.

Determining the priority of the various received messages indicates whether a particular message should be accepted or throttled. In one example, not every message is opened, which reduces the computational cost of an overload control algorithm that accounts for relative priorities. Without determining the priority of unopened messages, some are throttled (i.e., dropped or delayed), which accomplishes the needed overload control. By not opening such messages, the computational cost associated with the priority-sensitive overload algorithm is reduced.

In one example, statistical probabilities are used to determine how many messages to open and how many can be throttled without being opened. The arrival rate of messages provides information indicating how many messages of a particular class are received within a given time. Determining the arrival rate and the number of messages to accept from each message class makes it possible to determine a minimum number of messages to open within which the acceptable messages will be found.

This minimum number of messages to open preferably includes a sufficient number of messages such that the acceptable messages will be included. In one example, there will be some messages within the sufficient number that will be opened and then throttled. But even in this circumstance, less than all arriving messages are opened and the benefits of reducing the number of opened messages are still realized. Setting the sufficient number will depend, in part, on how sensitive the algorithm is going to be to computational cost. Because opening messages is computationally expensive, minimizing the number of messages to be opened to determine their priority class keeps the computational cost of the algorithm down. Those skilled in the art who have the benefit of this description will be able to select criteria for setting a sufficient number to meet their particular needs.

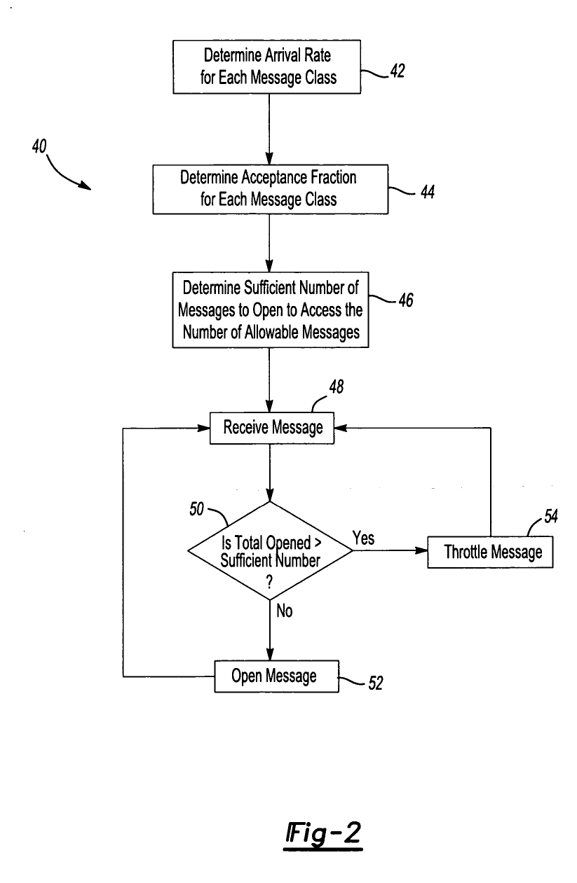

FIG. 2 includes a flow chart diagram 40 that summarizes the approach of one example. The steps outlined in FIG. 2 are performed within each control interval in this example.

At 42, the arrival rate for each message class is determined. As known, a variety of priority levels for different message classes may be assigned and determining arrival rates can be accomplished in a known manner. At 44, an acceptance fraction (i.e., the number of allowable messages within a control interval) for each message class is determined. At 46, the arrival rate information and the acceptance fraction information is used to determine a sufficient number of messages to open to access the number of allowable messages.

At 48, messages are received and opened until the sufficient number of messages has been reached. This is shown schematically at 50 by comparing the total number of opened messages to the sufficient number for a particular control interval. If the sufficient number of messages have not yet been opened, the message is opened at 52 and the next message is processed. Once the sufficient number of messages has been opened, the messages are throttled at 54 without being opened.

In one example, the arrival rate information from one control interval is used as the arrival rate for determining the sufficient number for at least one subsequent control interval. In one example, each control interval has an arrival rate associated with it. The arrival rate for each control interval is determined and then used for determining the sufficient number of messages to be opened in a next, subsequent control interval. This approach assumes that the arrival rate will not substantially change from one control interval to the next.

With changes in the arrival rate, the sufficient number of messages is changed so that different numbers of messages may be opened during different control intervals, depending on the arrival rate information.

In one example,

$${N}_{T} = {\sum }_{i = 1}^{M} a ( i )$$

is the expected number of messages to arrive in a subsequent control interval. If dⱼ=(1-fⱼ)*a(j) is the number of messages to be throttled, the sufficient number of messages to open can be determined from the following equation:

$${O}_{j} = {d}_{j} * ( \frac{{N}_{T}}{a ( j )} ) = ( 1 - {f}_{j} ) * {N}_{T} ;$$

where (fⱼ) is the acceptance fraction, which can be determined in a known manner.

It follows that a total number of messages to open as the sufficient number to include opening all of the messages that will be accepted is given by the following equation:

$${O}_{T} = {max}_{j} ( {O}_{j} ) = {N}_{T} * ( {max}_{j} ( 1 - {f}_{j} ) ) = {N}_{T} * ( 1 - ( {min ( {f}_{j} )}_{j} ) )$$

According to one example, the acceptance fraction for each message type depends upon the arrival rate of the corresponding message type at a given time (i.e., during a control interval). By changing the acceptance fraction responsive to a changing arrival rate, the example overload control adapts to various communication situations to provide optimized overload control.

For example, when the arrival rate of high priority messages exceeds that of low priority messages, it may be advisable to drop more high priority messages compared to a situation where the arrival rate of high priority messages is relatively low compared to low priority messages. Monitoring the arrival rate, using known techniques, provides for changing the acceptance fraction for at least one message type when the arrival rate for that (or another) message type changes in a manner that makes overload control more efficient if the acceptance fraction were changed.

In one example, an overall acceptance fraction is determined for a processor. An acceptance fraction for each message type, class or priority also is determined. The overall acceptance fraction, in part, determines the acceptance fraction for each different message type. The priority or importance assigned to each message type also dictates the acceptance fraction for each. According to this example, the arrival rate associated with each message type also dictates each acceptance fraction. As arrival rate changes, the acceptance fraction may be changed for better overload control. In one example, multiple acceptance fraction changes are made when even one arrival rate changes.

By utilizing a relationship between arrival rate and acceptance fraction, the disclosed approach adapts to changing overload conditions in a manner that is far superior to prior overload control algorithms that were not capable of adapting to non-stationary criteria such as arrival rate. The arrival rate itself can be determined from the subset of the opened messages.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A method of handling message overload, comprising:
throttling a number of unopened messages based upon an arrival rate of the messages.

2. The method of claim 1, including using the arrival rate to determine a sufficient number of messages to open such that a desired number of messages is opened.

3. The method of claim 2, including
determining an arrival rate for each of a plurality of message classes; and
determining the sufficient number of messages to be opened based on the arrival rate of each class.

4. The method of claim 2, including determining the sufficient number of messages to be opened based at least in part on the arrival rate of the messages.

5. The method of claim 4, including determining a new sufficient number of messages to be opened responsive to a change in the arrival rate.

6. The method of claim 2, including determining the sufficient number for a control interval.

7. The method of claim 6, including using an arrival rate determined in a first control interval to determine the sufficient number for a second, subsequent control interval.

8. The method of claim 6, including determining an arrival rate during each of a plurality of control interval and updating the sufficient number of messages for each corresponding next control interval responsive to the determined arrival rate.

9. The method of claim 1, wherein throttling includes at least one of discarding a message or delaying processing of a message.

10. A method of handling message overload, comprising:
determining an allowable number of messages;
determining an arrival rate of arriving messages;
using the determined arrival rate for determining at least one of
a number of unopened arriving messages to accept such that the determined number of accepted messages includes the determined allowable number, or
a number of unopened arriving messages to throttle.
